(19) United States
(12) Patent Application Publication
(10) Pub. No.: US 2008/0028432 A1
(43) Pub. Date: Jan. 31, 2008

(54) Method and apparatus of communication between embedded cable modem and embedded set-top box

(75) Inventors: Gyung-pyo Hong, Yongin-si (KR); Young-min Park, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/711,091

(22) Filed: Feb. 27, 2007

(30) Foreign Application Priority Data
Jul. 28, 2006 (KR) 10-2006-0071569

(51) Int. Cl. H04N 7/173

(52) U.S. Cl. 725/111

(57) ABSTRACT

An apparatus and method for communication between an embedded cable modem and an embedded set-top box in a DOCSIS Set-top Gateway (DSG)-based digital broadcast receiving apparatus are provided. The apparatus includes an embedded cable modem which receives or transmits messages from or to an embedded set-top box through a number of unidirectional ports according to message types.

### CROSS-REFERENCE TO RELATED PATENT APPLICATION

This application claims priority from Korean Patent Application No. 10-2006-0071569, filed on Jul. 28, 2006, in the Korean Intellectual Property Office, the disclosure of which is incorporated herein in its entirety by reference.

### BACKGROUND OF THE INVENTION

1. Field of the Invention

Apparatuses and methods consistent with the present invention relate to cable broadcasting, and more particularly, to a method of communication between an embedded cable modem and an embedded set-top box in a DOCSIS Set-to Gateway (DSG)-based digital broadcast receiving apparatus.

2. Description of the Related Art

A DOCSIS Set-top Gateway (DSG) is an interface method for receiving or transmitting digital broadcast-related data between a Data Over Cable Service Interface Specifications Cable Modem Termination System (DOCSIS CMTS) and a DOCSIS cable modem. Conventionally, since digital broadcast-related data (hereinafter, referred to as DSG data) is received or transmitted through out-of-band dedicated channels between the CMTS and the cable modem, receiving or transmitting such DSG data is called “Out-of-band (OOB) messaging”. Using this method, the DSG data is not transmitted through broadcast channels. In the DSG, it is defined that the OOB messaging is performed according to the DOCSIS which is a cable modem specification defined to provide Internet services. Messages transferred through the OOB messaging include a Conventional Access (CA) message, a Service Information (SI) message, an Electronic Program Guide (EPG) message, an Emergency Alert System (EAS) message, etc.

FIG. 1 is a block diagram illustrating a structure of a DSG-based cable network.

Referring to FIG. 1, the DSG-based cable network includes a DSG server, a DSG agent, an embedded cable modem (eCM), an embedded set-top box (eSTB), and a cable card (a DSG client controller). The eCM and the eSTB is included in a host device based on an open cable specification. The host device may be a DSG compatible digital television.

The eCM receives DSG data generated by the DSG server. The DSG server and the DSG agent are commonly called a DSG headend. In order to allow the eCM to select a packet that is to be received from among packets multi-casted from the DSG headend to the cable network, the cable card should transfer filtering information such as a MAC address of a DSG tunnel to the eCM. Accordingly, the eSTB, which include an interface between the eCM and the cable card, must receive a command from the cable card and control the eCM on the basis of the command.

However, so far, there has been provided no standard (including the DSG) which specifically defines a message exchange method or protocol between an eCM and an eSTB. Thus, if a manufacturer of an eCM is different from a manufacturer of an eSTB, the eCM is not compatible with the eSTB, which causes difficulties in implementing a DSG-based digital broadcast receiving apparatus.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above. Thus, an aspect of the present invention is to provide a method of exchanging messages between an embedded cable modem and an embedded set-top box included in a DSG-compatible digital broadcast receiving apparatus.

According to an aspect of the present invention, there is provided a digital broadcast receiving apparatus including an embedded cable modem and an embedded set-top box, wherein the embedded cable modem receives or transmits a plurality of messages from or to the embedded set-top box through a number of unidirectional ports according to types of messages transmitted or received.

The ports include a first port for a first type message used to allow the embedded set-top box to transfer a command to the embedded cable modem, a second port for a second type message used to allow the embedded cable modem to respond to the first type message, a third port for a third type message used to allow the embedded cable modem to inform the embedded set-top box of an event, and a fourth port for a fourth type message used to allow the embedded cable modem to transfer a packet transmitted by a DOCSIS Set-top Gateway Cable Modem Termination System (DSG CMTS) to the embedded set-top box.

The first type message includes a first field in which a sequence number of the first type message is recorded, a second field in which an identifier for specifying a subtype of the first type message is recorded, a third field in which content of the first type message is recorded, and a fourth field in which length information of the third field is recorded.

The second type message includes a first field in which a sequence number of the second type message is recorded, a second field in which an identifier for specifying a subtype of the second type message is recorded, a third field in which content of the second type message is recorded, and a fourth field in which length information of the third field is recorded.

The third type message includes a first field in which a sequence number of the third type message is recorded, a second field in which an identifier for specifying a subtype of the third type message is recorded, a third field in which content of the third type message is recorded, and a fourth field in which length information of the third field is recorded.

The fourth type message includes a first field in which a sequence number of the fourth type message is recorded, a second field in which an identifier for specifying a DSG tunnel for receiving the packet is recorded, a third field in which the packet is recorded, and a fourth field in which length information of the third field is recorded.

The messages may be transmitted or received using a User Datagram Protocol (UDP) or a Transmission Control Protocol (TCP).

According to another aspect of the present invention, there is provided a method of communication between an embedded cable modem and an embedded set-top box in a digital broadcast receiving apparatus, wherein the embedded cable modem receives or transmits a plurality of messages from or to the embedded set-top box through a number of unidirectional ports according to types of the messages.

According to another aspect of the present invention, there is provided a computer readable recording medium having embodied thereon a program for executing the method.

According to another aspect of the present invention, there is provided an embedded cable modem apparatus receiving or transmitting a plurality of messages from or to the embedded set-top box according to types of the messages through a predetermined number of uni-directional ports.

### BRIEF DESCRIPTION OF THE DRAWINGS

The above and other features and aspects of the present invention will become more apparent by describing in detail exemplary embodiments thereof with reference to the attached drawings in which:

FIG. 1 is a block diagram illustrating a structure of a DOCSIS Set-to Gateway (DSG)-based cable network;

FIG. 2 is a conceptual view for explaining a method of communication between an embedded cable modem and an embedded set-top box in a DSG-based digital broadcast receiving apparatus according to an exemplary embodiment of the present invention;

FIGS. 3A and 3B are views for explaining a first type message according to an exemplary embodiment of the present invention;

FIGS. 4A and 4B are views for explaining a second type message according to an exemplary embodiment of the present invention;

FIGS. 5A and 5B are views for explaining a third type message according to an exemplary embodiment of the present invention;

FIG. 6 is a view for explaining a fourth type message according to an exemplary embodiment of the present invention;

FIG. 7 is a flowchart illustrating a method of communication between an embedded cable modem and an embedded set-top box in a DSG basic mode; and

FIG. 8 is a flowchart illustrating a method of communication between an embedded cable modem and an embedded set-top box in a DSG advanced mode.

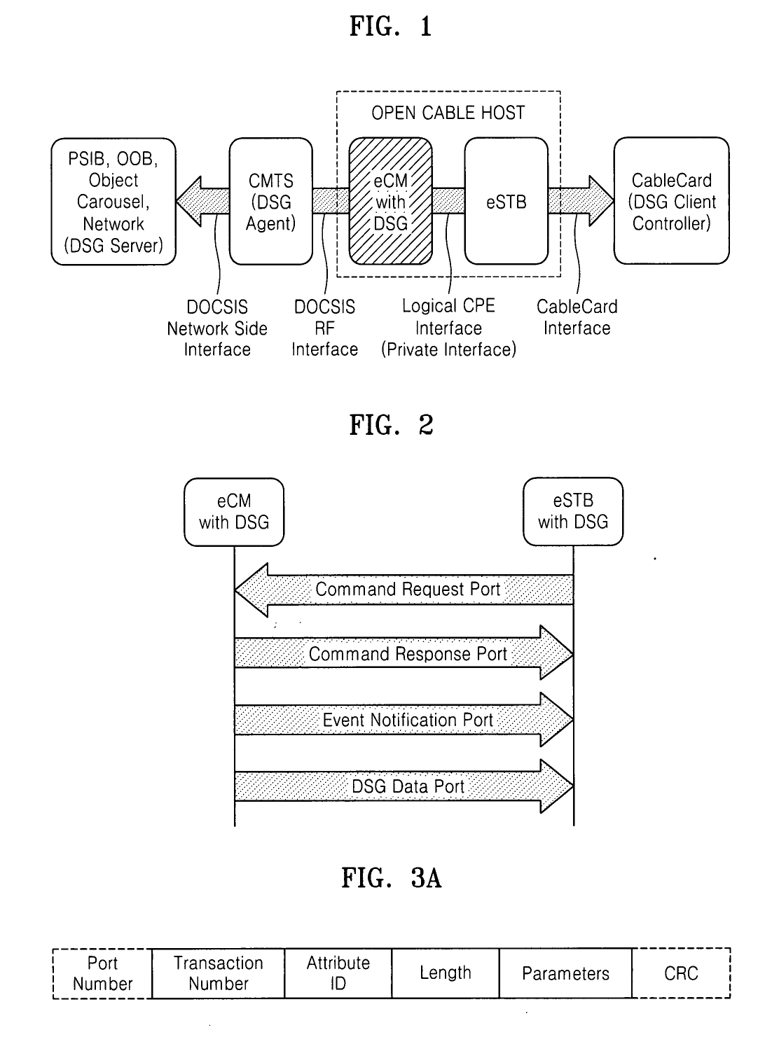

### DETAILED DESCRIPTION OF THE INVENTION

Hereinafter, exemplary embodiments of the present invention will be described in detail with reference to the appended drawings.

FIG. 2 is a conceptual view of explaining a method of communication between an embedded cable modem (eCM) and an embedded set-top box (eSTB) in a DSG-based digital broadcast receiving apparatus according to the present invention.

Referring to FIG. 2, the eCM and the eSTB receive and transmit messages through four unidirectional ports of a command request port, a command response port, an event notification port, and a DSG data port. These four ports are classified according to types of messages.

That is, the command request port is a passage for a first type message, through which the eSTB transfers a command requested by a DSG client controller (that is, a cable card) to the eCM.

The command response port is a passage for a second type message, through which the eCM transfers to the eSTB a response message for the command received through the command request port.

The event notification port is a passage for a third type message used to notify an event generated by the eCM to the eSTB.

The DSG data port is a passage for a fourth type message used to transfer to the eSTB a packet received through a DSG tunnel among packets transmitted by a DSG CMTS.

The first through fourth type messages can be received and transmitted between the eCM and eSTB using an User Datagram Protocol (UDP) or a Transmission Control Protocol (TCP). A port number can be recorded in a UDP or TCP header of each message. Physical communication between the eCM and eSTB can be performed through a Universal Serial Bus (USB) or the Ethernet, or can be performed based on an IP address in an upper protocol layer.

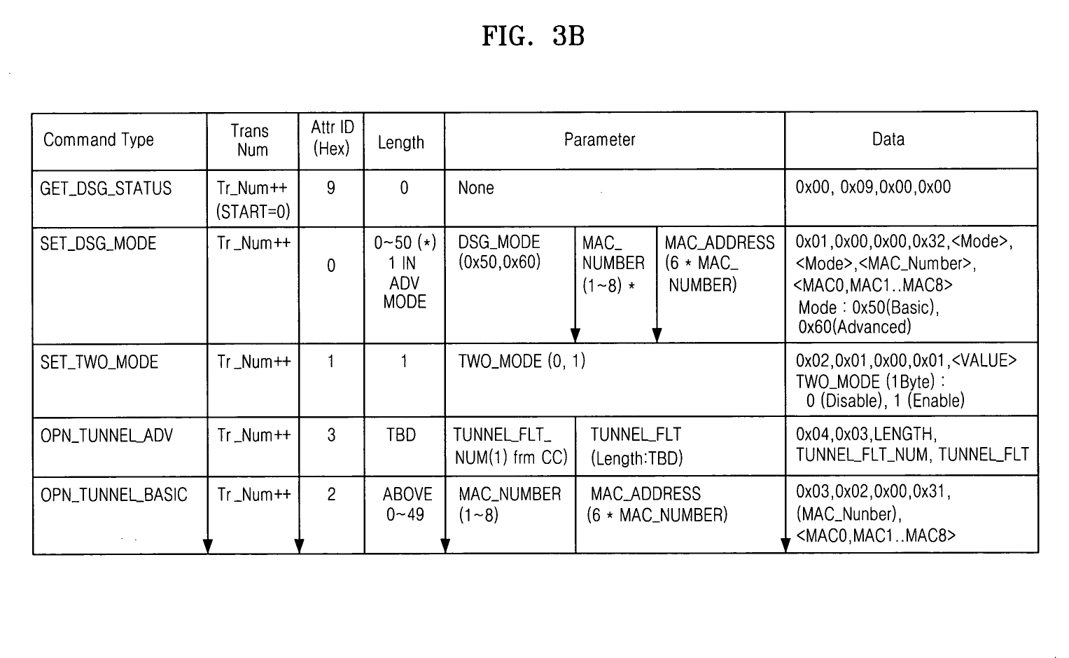

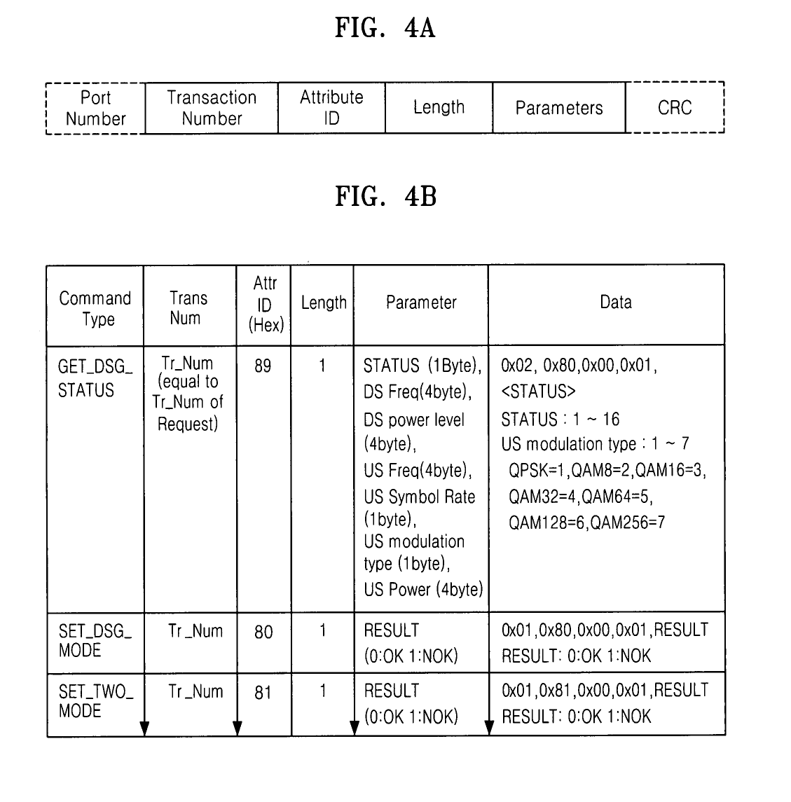

FIGS. 3A and 3B are views for explaining a first type message according to an exemplary embodiment of the present invention.

In FIG. 3A, a format of the first type message is illustrated. As illustrated in FIG. 3A, the first type message includes a transaction number field, an attribute ID field, a length field, and a parameter field.

Here, the transaction number is a sequence number assigned to each of messages which the eCM receives from the eSTB through the command request port. The eCM and eSTB can determine whether the corresponding message has been omitted with reference to the transaction number.

The attribute ID is an identifier for allowing the eCM to classify a message received through the command request port according to the type of the message.

Since the first type message includes various kinds of messages, an Attribute ID is recorded in the attribute field of the first type message in order to classify the first type message according to the kind of the first type message.

In the parameter field, content of the first type message is recorded, and in the length field, length information of the parameter field is recorded.

Meanwhile, in FIG. 3A, a port number field and a Cyclic Redundancy Checking (CRC) field, which are optional fields, are represented by dotted lines. In the port number field, a port identifier for identifying each of ports can be recorded. For example, when the eCM and eSTB receive and transmit messages through the UDP, different UDP port numbers can be recorded in the UDP headers of messages received and transmitted through respective ports, so as to allow a UDP layer to identify the types of the respective messages. However, if messages received and transmitted between the eCM and eSTB have the same UDP port value, it is possible to add a field in which a port number is recorded to a payload of each of UDP packets, in order to classify a port corresponding to each message. In the CRC field, information for detecting a CRC error of each message is recorded.

FIG. 3B shows a table which lists detailed examples of the first type message.

As illustrated in FIG. 3B, the first type message can include a GET_DSG_STATUS message, a SET_DSG_MODE message, a SET_TWO_MODE message, an OPN_TUNNEL_ADV message, and an OPN_TUNNEL_BASIC message, and proper values can be assigned to respective fields. The respective field values illustrated in FIG. 3B are only exemplary, and changes, additions, and deletions are possible according the various methods of implementation.

Referring to FIG. 3B, the GET_DSG_STATUS message is a message for requesting status information of an eCM, and the SET_DSG_MODE message is a message through which the eSTB informs the eCM of a DSG mode. If a basic mode is set, a MAC address of a DSG tunnel will be included.

The SET_TWO_MODE message is a message for informing the eCM of whether a two-way mode or an one-way mode is set. In FIG. 3B, it is assumed that the two-way mode is set when a value of the parameter field is 0, and the one-way mode is set when a value of the parameter field is 1.

The OPN_TUNNEL_ADV message is a message through which the eSTB requests the eCM to open a DSG tunnel in an advanced mode, and the OPN_TUNNEL_BASIC message is a message through which the eSTB requests the eCM to open the DSG tunnel in a basic mode.

In FIG. 3B, the five messages are only exemplary, and a message for setting timers Tdsg1 through Tdsg4 in the eCM, a message for informing down-stream frequency information, etc., may be further included.

FIGS. 4A and 4B are views for explaining a second type message according to an exemplary embodiment of the present invention.

In FIG. 4A, a format of the second type message is illustrated. As illustrated in FIG. 4A, the second type message includes a transaction number field, an attribute ID field, a length field, and a parameter field.

Here, a value recorded in the transaction number field of the second type message is equal to that recorded in the transaction number field of the first type message. That is, referring to FIGS. 2 and 4A, a transaction number of a message transferred to the eCM through the command request port is equal to a transaction number of a response message transferred to the eSTB through the command response port. Since the format of the second type message is the same as the format of the first type message illustrated in FIG. 3A, a detailed description therefor will be omitted.

Meanwhile, FIG. 4B shows a table which lists detailed examples of the second type message. Messages illustrated in FIG. 4B are response messages for the first type message. The name of each message is the same as that of the corresponding first type message. The parameter field stores a result value corresponding to a command transferred to the eCM through a first type message. For example, 1 byte of status information, 4 bytes of down-stream frequency information, 4 bytes of power level, etc. are included in the parameter field of the GET_DSG_STATUS message, as illustrated in FIG. 4B.

The messages illustrated in FIG. 4B and the corresponding field values are only exemplary, and changes, additions, and deletions are possible according to the various possible methods of implementation.

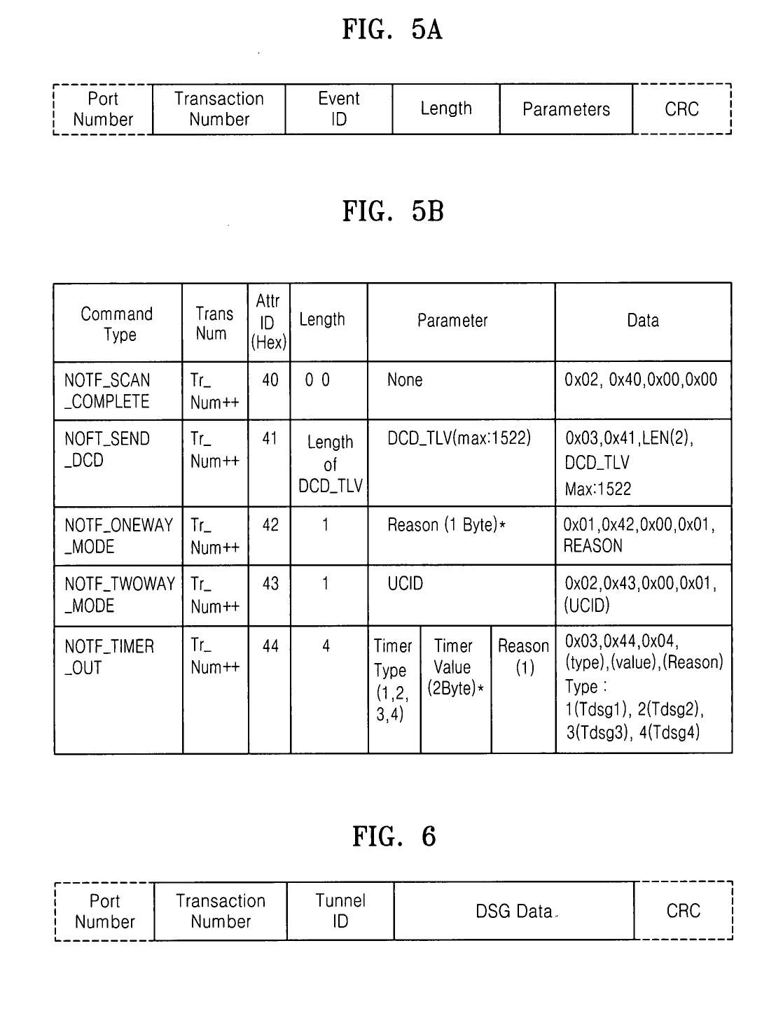

FIGS. 5A and 5B are views for explaining a third type message according to an exemplary embodiment of the present invention.

In FIG. 5A, a format of the third type message is illustrated. Referring to FIG. 5A, the third type message includes a transaction number field, an event ID field, a length field, and a parameter field.

Since details for the fields are described above with reference to FIG. 4A, a detailed description therefor will be omitted. In FIG. 5, the event ID is an identifier for identifying an event generated by an eCM.

Meanwhile, FIG. 5B shows a table which lists detailed examples of the third type message.

As illustrated in FIG. 5B, the third type message includes a NOTF_SCAN_COMPLETE message, a NOFT_SEND_DCD message, a NOTF_ONEWAY_MODE message, a NOTF_TWOWAY_MODE message, and a NOTF_TIMER_OUT message, etc.

The NOTF_SCAN_COMPLETE message is a message for informing that scanning is complete when no Lock information is obtained after an eCM scans a down-stream frequency.

The NOTF_SEND_DCD message is a message through which the eCM receives DCD information and transmits it to an eSTB in an advanced mode.

The NOTF_ONEWAY_MODE message is a message for informing the eSTB that a one-way mode is started after the eCM locks a down-stream channel. The NOTF_TWOWAY_MODE message is a message for informing the eSTB that a two-way mode is started after the eCM locks the down-stream channel.

The NOTF_TIMER_OUT message is a message for informing the eSTB of “time-out” when no operation corresponding to each timer occurs in a period corresponding to a timer value set by the eSTB.

The messages illustrated in FIG. 5B and the corresponding field values are only exemplary, and changes, additions, and deletions are possible according to the various methods of implementation.

FIG. 6 is a view for explaining a fourth type message according to an exemplary embodiment of the present invention.

The fourth type message is a message for allowing an eCM to transmit a packet received from a DSG CMTS to an eSTB. An identifier of a DSG tunnel used for receiving the packet is recorded in a tunnel ID field of the fourth type message, and the packet received from the DSG CMTS to the eCM is recorded in a DSG data field of the fourth type message.

Accordingly, the eCM transmits the fourth type message to the eSTB, thereby transparently transferring the packet received from the DSG CMTS to the eSTB.

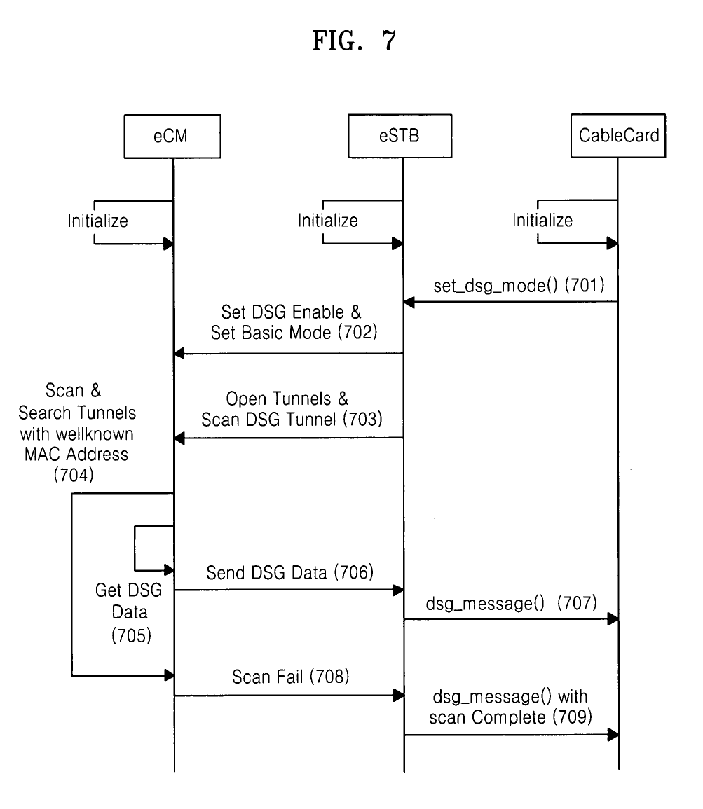

FIG. 7 is a flowchart illustrating a method of communication between an eCM and an eSTB in a DSG basic mode. A method of communication between a cable card and an eSTB is defined in the open cable specification, and the present invention defines a method of communication between an eSTB and an eCM.

Referring to FIG. 7, in operation 701, the cable card requests the eSTB to set the eCM to a basic mode. At this time, MAC address information of a DSG tunnel is transferred to the eSTB.

Then, in operation 702, the eSTB, which has received the request of the cable card, requests the eCM to set a DSG receiving mode to the basic mode. For this request, the SET_DSG_MODE message of the first type message illustrated in FIG. 3B can be used. That is, if the eSTB transmits the SET_DSG_MODE message through a command request port (not shown), the eCM sets the DSG receiving mode to the basic mode and then informs the eSTB of the result through a command response port (not shown). Here, a transaction number of the SET_DSG_MODE message transmitted from the eSTB through the command request port will be equal to a transaction number of a response SET_DSG_MODE message transmitted to the eSTB through the command response port, as described above.

In operation 703, the eSTB requests the eCM to open DSG tunnels and scan a frequency band. For this request, an OPN_TUNNEL_BASIC message can be used. The eCM informs the eSTB of a result indicating whether the DSG tunnels are successfully opened, through the command response port.

In operation 704, the eCM, which has received the OPN_TUNNEL_BASIC message, scans the DSG tunnels, using a MAC address (that is, a “well-known MAC address”) received from the cable card.

In operation 705, the eCM receives DSG data (that is, a DSG packet) from a DSG CMTSM, through the DSG tunnels. Then, in operation 706, the eCM transfers the DSG packet to the eSTB. At this time, the fourth type message illustrated in FIG. 6 is used. The fourth type message is transmitted to the eCM through a DSG data port (not shown).

In operation 707, the eSTB transfers the DSG packet received from the eCM to the cable card.

Meanwhile, if the DSG tunnel scanning fails, in operation 708, the eCM informs the eSTB that DSG tunnel scanning fails. At this time, the NOTF_SCAN_COMPLETE message of the third type message illustrated in FIG. 5B can be used.

In operation 709, the eSTB, which has received the NOTF_SCAN_COMPLETE message through an event notification port (not shown), informs the cable card that DSG tunnel scanning fails.

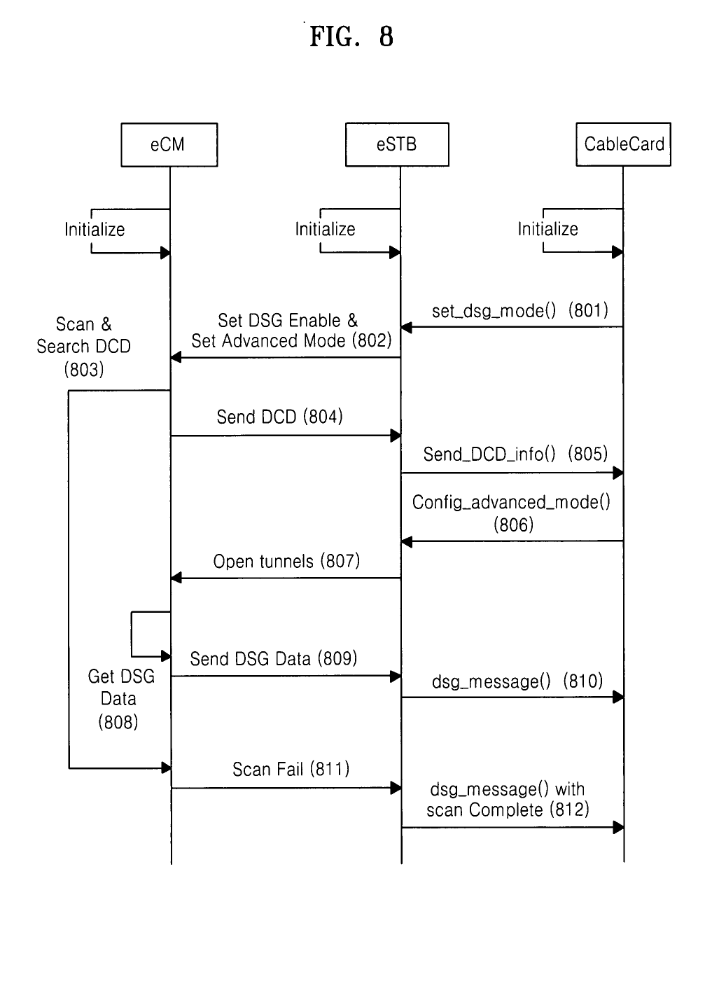

FIG. 8 is a flowchart illustrating a method of communication between an eCM and an eSTB in a DSG advance mode.

Referring to FIG. 8, in operation 801, a cable card requests the eSTB to set the eCM to an advanced mode. In the advanced mode, since a Downstream Channel Descriptor (DCD) is used, MAC address information of a DSG tunnel is not transferred, differently from the case illustrated in FIG. 7.

Then, in operation 802, the eSTB requests the eCM to set a DSG receiving mode to the advanced mode. At this time, the SET_DSG_MODE message of the first type message illustrated in FIG. 3B can be used. After setting the DSG receiving mode to the advanced mode, the eCM informs the eSTB of the result through a command response port (not shown).

In operation 803, the eCM can scan a frequency band and searches for DCD information. In operation 804, if the DCD information is acquired, the eCM transmits the DCD information to the eSTB. At this time, the NOFT_SEND_DCD message of the third type message illustrated in FIG. 5B can be used. In operation 805, the eSTB transfers the DCD information received from the eCM to the cable card.

In operation 806, the cable card transmits filtering information created using the DCD information to the eSTB. In operation 807, the eSTB transfers the filtering information to the eCM and requests the eCM to open a DSG tunnel. At this time, the OPN_TUNNEL_ADV message of the first type message illustrated in FIG. 3B can be used.

In operation 808, the eCM receives a DSG packet using the filtering information. In operation 809, the eCM receives the DSG packet to the eSTB. At this time, the fourth type message can be used. In operation 810, the eSTB transfers the DSG packet received from the eCM to the cable card.

Meanwhile, if the eCM fails to receive the DCD information, in operation 811, the eCM informs the eSTB of a scan failure. At this time, the NOTF_SCAN_COMPLETE message of the third type message illustrated in FIG. 5B can be used. In operation 812, the eSTB, which has received the NOTF_SCAN_COMPLETE message through an event notification port (not shown), informs the cable card of the scan failure.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet).

As described above, according to the exemplary embodiments of the present invention, by defining a method of communication between an embedded cable modem and an embedded set-top box in a DSG-based digital broadcast receiving apparatus, manufacturers of embedded cable modems and manufacturers of embedded set-top boxes can easily develop new products and upgrade products.

Also, since an embedded cable modem receives or transmits messages from or to an embedded set-top box through dedicated ports classified according to functions of the messages, errors generated when reception/transmission of a message with a specific function does not influence different functions.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A digital broadcast receiving apparatus comprising:
an embedded cable modem; and
an embedded set-top box,
wherein the embedded cable modem receives or transmits a plurality of messages from or to the embedded set-top box through a number of uni-directional ports according to a message type.

2. The apparatus of claim 1, wherein the digital broadcast receiving apparatus supports a DOCSIS Set-top Gateway (DSG) specification.

3. The apparatus of claim 2, wherein the ports comprise a first port configured to transfer a command in a first type message between the embedded set-top box and the embedded cable modem, a second port configured to transmit a second type message from the embedded cable modem as a response to the first type message, a third port configured to transmit a third type message from the embedded cable modem to inform the embedded set-top box of an event, and a fourth port configured to transmit a fourth type message from the embedded cable modem to transfer a packet transmitted by a DOCSIS Set-top Gateway Cable Modem Termination System (DSG CMTS) to the embedded set-top box.

4. The apparatus of claim 3, wherein the first type message comprises a first field in which a sequence number of the first type message is recorded, a second field in which an identifier which specifies a subtype of the first type message is recorded, a third field in which content of the first type message is recorded, and a fourth field in which length information of the third field is recorded.

5. The apparatus of claim 3, wherein the second type message comprises a first field in which a sequence number of the second type message is recorded, a second field in which an identifier which specifies a subtype of the second type message is recorded, a third field in which content of the second type message is recorded, and a fourth field in which length information of the third field is recorded.

6. The apparatus of claim 3, wherein the third type message comprises a first field in which a sequence number of the third type message is recorded, a second field in which an identifier for specifying a subtype of the third type message is recorded, a third field in which content of the third type message is recorded, and a fourth field in which length information of the third field is recorded.

7. The apparatus of claim 3, wherein the fourth type message comprises a first field in which a sequence number of the fourth type message is recorded, a second field in which an identifier for specifying a DSG tunnel for receiving the packet is recorded, a third field in which the packet is recorded, and a fourth field in which length information of the third field is recorded.

8. The apparatus of claim 1, wherein the messages are transmitted or received using a User Datagram Protocol (UDP) or a Transmission Control Protocol (TCP).

9. A method of communication between an embedded cable modem and an embedded set-top box in a digital broadcast receiving apparatus, the method comprising:
transmitting or receiving a plurality of messages by the embedded cable modem from or to the embedded set-top box through a number of unidirectional ports according to a message type.

10. The method of claim 9, wherein the digital broadcast receiving apparatus supports a DOCSIS Set-top Gateway (DSG) specification.

11. The method of claim 10, wherein the ports comprise a first port configured to transmit a first type message from the embedded set-top box to transfer a command to the embedded cable modem, a second port configured to transmit a second type message from the embedded cable modem as a response to the first type message, a third port configured to transmit a third type message from the embedded cable modem to inform the embedded set-top box of an event, and a fourth port configured to transmit a fourth type message from the embedded cable modem to transfer a packet transferred from a DOCSIS Set-top Gateway Cable Modem Termination System (DSG CMTS) to the embedded set-top box.

12. The method of claim 10, wherein the first type message comprises a first field in which a sequence number of the first type message is recorded, a second field in which an identifier which specifies a subtype of the first type message is recorded, a third field in which content of the first type message is recorded, and a fourth field in which length information of the third field is recorded.

13. The method of claim 10, wherein the second type message comprises a first field in which a sequence number of the second type message is recorded, a second field in which an identifier which specifies a subtype of the second type message is recorded, a third field in which content of the second type message is recorded, and a fourth field in which length information of the third field is recorded.

14. The method of claim 10, wherein the third type message comprises a first field in which a sequence number of the third type message is recorded, a second field in which an identifier for specifying a subtype of the third type message is recorded, a third field in which content of the third type message is recorded, and a fourth field in which length information of the third field is recorded.

15. The method of claim 10, wherein the fourth type message comprises a first field in which a sequence number of the fourth type message is recorded, a second field in which an identifier for specifying a DSG tunnel for receiving the packet is recorded, a third field in which the packet is recorded, and a fourth field in which length information of the third field is recorded.

16. The method of claim 9, wherein the messages are received or transmitted using a User Datagram Protocol (UDP) or a Transmission Control Protocol (TCP).

17. A computer readable recording medium having embodied thereon a program for executing the method of claim 9.

18. An embedded cable modem apparatus receiving or transmitting a plurality of messages from or to the embedded set-top box according to message types through a number of unidirectional ports.

19. The apparatus of claim 18, wherein the embedded cable modem apparatus and the embedded set-top box supports a DOCSIS Set-top Gateway (DSG) specification.

20. The apparatus of claim 19, wherein the ports comprise a first port which receives a first type message which transmits a command of the embedded set-top box, a second port which transmits a second type message as a response to the first type message to the embedded set-top box, a third port which transmits a third type message which informs the embedded set-top box of an event, and a fourth port which transmits a fourth type message which transmits a packet transmitted by a DOCSIS Set-top Gateway Cable Modem Termination System (DSG CMTS) to the embedded set-top box.

21. An embedded set-top box apparatus receiving or transmitting a plurality of messages from or to an embedded cable modem according to message types, through a number of uni-directional ports.

22. The apparatus of claim 20, wherein the embedded set-top box apparatus and the embedded cable modem supports a DOCSIS Set-top Gateway (DSG) specification.

23. The apparatus of claim 22, wherein the ports comprise a first port which transmits a first type message which transfers a command to the embedded cable modem, a second port which receives a second type message as a response to the first type message from the embedded cable modem, a third port which receives a third type message which informs the embedded cable modem of an event, and a fourth port which receives a fourth type message including a packet transmitted by the DSG CMTS from the embedded cable modem.
